(19) United States
(12) Patent Application Publication
(10) Pub. No.: US 2014/0359650 A1
(43) Pub. Date: Dec. 4, 2014

(54) TEXT INPUT METHOD, ELECTRONIC DEVICE, AND STORAGE MEDIUM

(71) Applicant: KABUSHIKI KAISHA TOSHIBA, Tokyo (JP)

(72) Inventor: Toshifumi Ohtake, Chofu-shi (JP)

(73) Assignee: KABUSHIKI KAISHA TOSHIBA, Tokyo (JP)

(21) Appl. No.: 14/079,110

(22) Filed: Nov. 13, 2013

(30) Foreign Application Priority Data
May 29, 2013 (JP) 2013-112895

(51) Int. Cl. H04N 21/422; H04N 21/4786; H04N 21/258; H04N 21/4227

(52) U.S. Cl. CPC H04N 21/42208; H04N 21/4227; H04N 21/4786; H04N 21/25816
USPC 725/25

(57) ABSTRACT

According to one embodiment, a text input method includes: displaying, by a first apparatus comprising a first display, a first input area configured to receive text input on the first display; providing, by the first apparatus, identification information of a second input area configured to be displayed on a second display of a second apparatus, the second input area corresponding to the first input area; providing, by the first apparatus, authentication information for using the second input area; and receiving, from a server, information indicative of text being input through the second input area.

### CROSS-REFERENCE TO RELATED APPLICATIONS

This application is based upon and claims the benefit of priority from Japanese Patent Application No. 2013-112895, filed May 29, 2013, the entire contents of which are incorporated herein by reference.

### FIELD

Embodiments described herein relate generally to a text input method, an electronic device, and a storage medium.

### BACKGROUND

Conventionally, there has been known a method that enables text to be input to a screen displayed on a television receiver by a device such as a tablet terminal. Such text input operation using the tablet terminal is simpler than the operation using a remote controller.

However, in the conventional techniques, there are required settings for cooperating the television receiver with other device such as the tablet terminal so as to enable the text to be input to the input screen of the television receiver by other device such as the tablet terminal, thereby requiring users to perform time-consuming operations.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of an overall configuration of one example of a system according to a first embodiment;

FIG. 2 is an exemplary block diagram of one example of a television receiver in the first embodiment;

FIG. 3 is an exemplary block diagram of one example of a functional configuration of the television receiver in the first embodiment;

FIG. 4 is an exemplary block diagram of one example of a tablet terminal in the first embodiment;

FIG. 5 is an exemplary block diagram of one example of a server in the first embodiment;

FIG. 6 is an exemplary flowchart of one example of a process performed by the system in the first embodiment;

FIG. 7 is an exemplary schematic diagram of one example of an input screen displayed on a display of the television receiver in the first embodiment;

FIG. 8 is an exemplary schematic diagram of one example of an input screen displayed on a display of the tablet terminal in the first embodiment;

FIG. 9 is an exemplary schematic diagram of one example of a mail transmission completion screen displayed on the display of the television receiver in the first embodiment;

FIG. 10 is an exemplary schematic diagram of one example of an input screen displayed on the display of the television receiver according to a modification of the first embodiment;

FIG. 11 is an exemplary flowchart of one example of a process performed by a system according to a second embodiment; and

FIG. 12 is an exemplary schematic diagram of one example of an input screen displayed on the display of the television receiver in the second embodiment.

### DETAILED DESCRIPTION

In general, according to one embodiment, a text input method comprises: displaying, by a first apparatus comprising a first display, a first input area configured to receive text input on the first display; providing, by the first apparatus, identification information of a second input area configured to be displayed on a second display of a second apparatus, the second input area corresponding to the first input area; providing, by the first apparatus, authentication information for using the second input area; and receiving, from a server, information indicative of text being input through the second input area.

The following describes embodiments and modifications with reference to the accompanying drawings. The following embodiments and modifications comprise identical components. The same components are labeled with the same reference numerals and duplicated descriptions thereof are omitted.

### First Embodiment

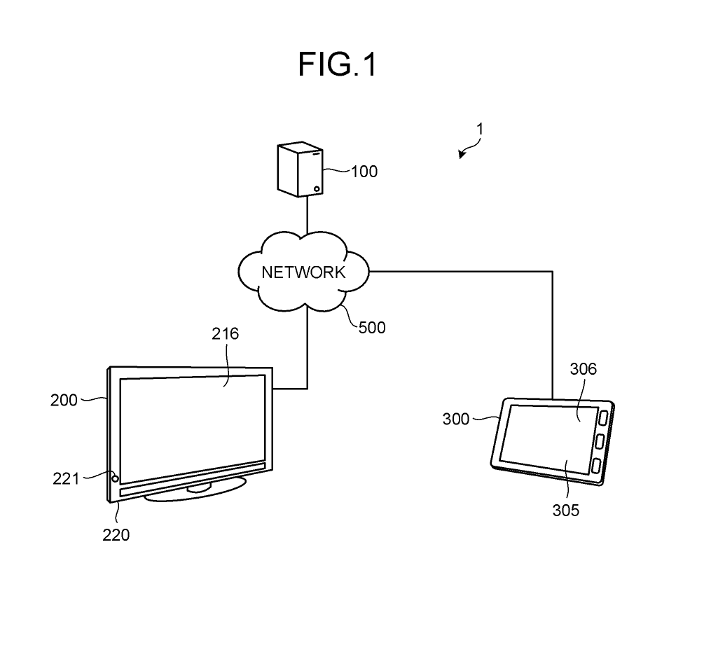

FIG. 1 is a schematic diagram illustrating one example of an overall configuration of a system 1 according to a first embodiment. In the first embodiment, as illustrated in FIG. 1, the system 1 (an information processing system) comprises a television receiver 200 (an electronic device), a tablet terminal 300 (an information processor or an input device), and a server 100. The television receiver 200, the tablet terminal 300, and the server 100 are communicably connected to each other through a wireless network 500 (an electrical communication line).

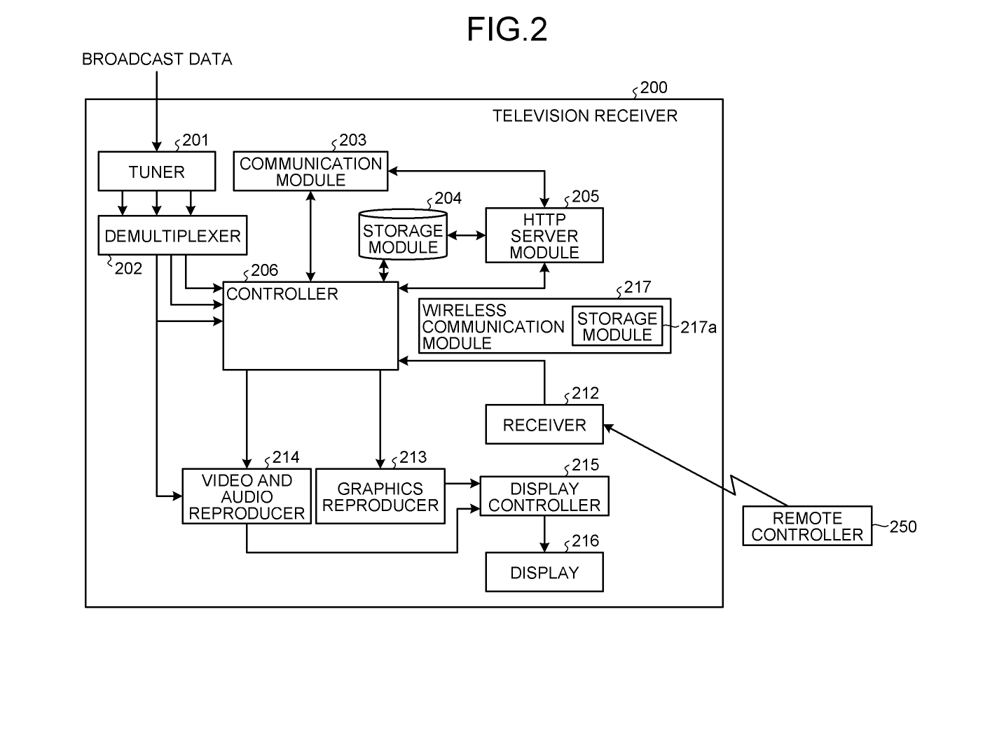

FIG. 2 is a block diagram illustrating one example of the television receiver 200 in the embodiment. In the embodiment, the television receiver 200 comprises a tuner (tuner module) 201, a demultiplexer (demux module) 202, a communication module 203, a storage module 204, a hyper text transfer protocol (HTTP) server module 205, a controller 206, a receiver 212, a graphics reproducer (graphics reproduction module) 213, a video and audio reproducer 214, a display controller 215, a display 216 (a first display), and a wireless communication module 217. The television receiver 200 also comprises a housing 220 that houses the components described above.

The tuner 201 comprises a plurality of tuners each of which can receive broadcast data, for example. In the embodiment, the tuner 201 can receive the respective pieces of broadcast data of a plurality of channels (three channels in the embodiment).

The demultiplexer 202 separates various types of data from the broadcast data received by the tuner 201. In the embodiment, the demultiplexer 202 separates various types of data from the broadcast data for each of the tuners comprised in the tuner 201. Broadcast video images and audio data separated by the demultiplexer 202 are sent to the video and audio reproducer 214.

The communication module 203 communicates with other devices. For example, the communication module 203 exchanges data between itself and the server 100 by communicating with the server 100 through the network 500.

The wireless communication module 217 communicates with other devices in a wireless manner (non-contact communication). For example, the wireless communication module 217 performs short-distance wireless communication with a wireless communication module 308 of the tablet terminal 300. The wireless communication between the wireless communication modules 217 and 308 is performed using electromagnetic waves for short-distance wireless communication used in radio frequency identification (RFID), for example. In the embodiment, the wireless communication module 217 is configured as a wireless reader and writer and comprises a storage module 217a. The wireless communication module 308 is configured as a wireless communication medium (an integrated circuit (IC) tag or a wireless tag). The housing 220 is provided with a reading mark 221 indicating a position of an antenna (reading unit) of the wireless communication module 217. The antenna of the wireless communication module 217 is housed behind the reading mark 221.

The display 216 may be a liquid crystal display (LCD) or an organic electroluminescent display (OELD), for example. A display screen of the display 216 is exposed from the housing 220. The display 216 displays an image based on the broadcast data received by the tuner 201 or an image based on the data received by the communication module 203 from the server 100.

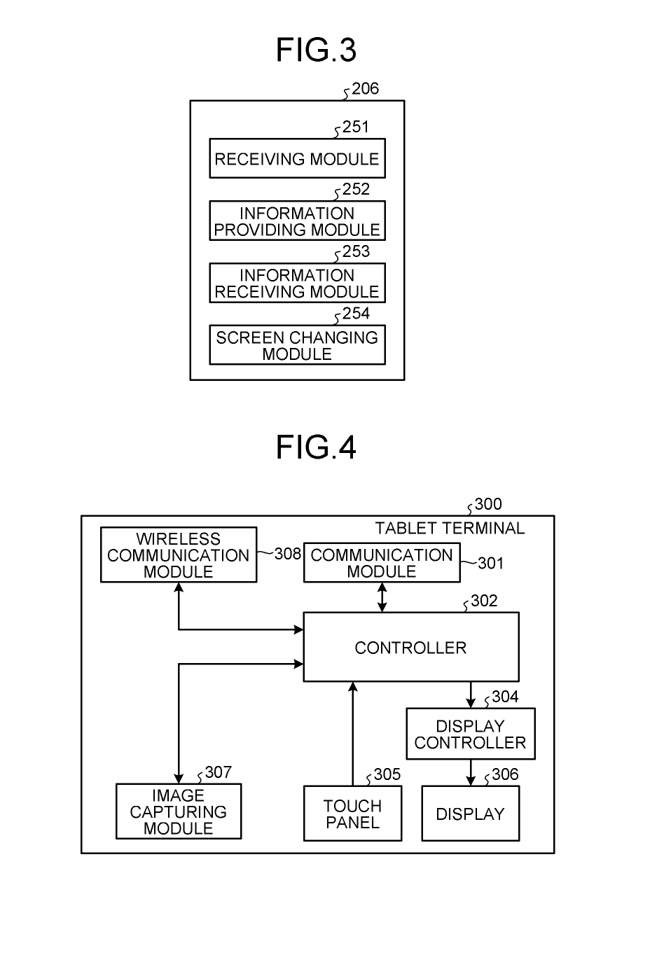

The controller 206 comprises a central processing unit (CPU) and a storage module, and controls respective components of the television receiver 200. The storage module of the controller 206 comprises a read only memory (ROM) and a random access memory (RAM), for example. The CPU cooperates with a computer program stored in the storage module for the controller 206 to function as a web browsing module. The web browsing module comprises a JavaScript (registered trademark) processor, a hyper text markup language (HTML) processor, a video and audio element processor, an application program interface (API) processor, and a cascading style sheet (CSS) processor, which are not illustrated. The web browsing module outputs acquired information to the graphics reproducer 213. In the embodiment, the CPU cooperates with a computer program stored in the storage module for the controller 206 to function as a receiving module 251, an information providing module 252, an information receiving module 253, and a screen changing module 254 as exemplarily illustrated in FIG. 3.

The HTTP server module 205 has a function of a typical web server. The HTTP server module 205 outputs relevant information stored in the storage module 204 in accordance with a request from the controller 206 (web browsing module), for example.

The storage module 204 stores therein relevant information separated (acquired) from the broadcast data by the demultiplexer 202, for example.

The video and audio reproducer 214 decodes the broadcast video images and audio data input from the demultiplexer 202, for example. The graphics reproducer 213 produces display data in a format processable by the display controller 215 from the relevant information that is input from the controller 206 and written in formats such as the HTML format, the CSS format, and the JavaScript (registered trademark) format.

The display controller 215 superimposes the broadcast video image decoded by the video and audio reproducer 214 and the display data produced by the graphics reproducer 213 so as to convert them into a video image signal in a format allowing the display 216 to display a video image. The display 216 displays the video image using the video image signal.

The receiver 212 receives a wireless signal (e.g., an infrared ray signal) from a remote controller 250. The remote controller 250 is provided with various keys such as a menu key, navigation keys, numeric keys, and an enter key.

FIG. 4 is a block diagram illustrating an example of the tablet terminal 300 in the embodiment. In the embodiment, the tablet terminal 300 comprises a communication module 301, a controller 302, a display controller 304, a touch panel 305, a display 306 (a second display), an image capturing module 307 (an acquisition module), the wireless communication module 308, for example.

The communication module 301 communicates with other devices. For example, the communication module 301 exchanges data between itself and the server 100 by communicating with the server 100 through the network 500.

The controller 302 comprises a CPU and a storage module, and controls respective components of the tablet terminal 300. The storage module of the controller 302 comprises a ROM and a RAM, for example. The CPU cooperates with a computer program for the controller 302 to function as a web browsing module. The web browsing module comprises a JavaScript (registered trademark) processor, an HTML processor, a video/audio element processor, an API processor, and a CSS processor (which are not illustrated), and outputs the received information to the display controller 304.

The display controller 304 causes the display 306 to display the information. In the embodiment, the display controller 304 produces display data in a format displayable by the display 306 from the information that is input from the controller 302 and written in formats such as the HTML format, the CSS format, and the JaveScript (registered trademark) format, for example.

The display 306 may be an LCD or an OELD, for example. The display 306 displays a video image using the display data input from the display controller 304. The touch panel 305 is layered on the display screen of the display 306. The touch panel 305 is an example of an input operating module that receives input operation of text. The input operating module may be a keyboard (not illustrated), for example.

The wireless communication module 308 performs the short-distance wireless communication with the wireless communication module 217 as described above, for example. The wireless communication module 308 stores the information transmitted from the wireless communication module 217 in its storage module and outputs the information to the controller 302.

The image capturing module 307 is configured with a charge-coupled device (CCD) image sensor or a complementary metal-oxide semiconductor (CMOS) image sensor, for example. The image capturing module 307 performs imaging to acquire information and outputs the acquired information to the controller 302.

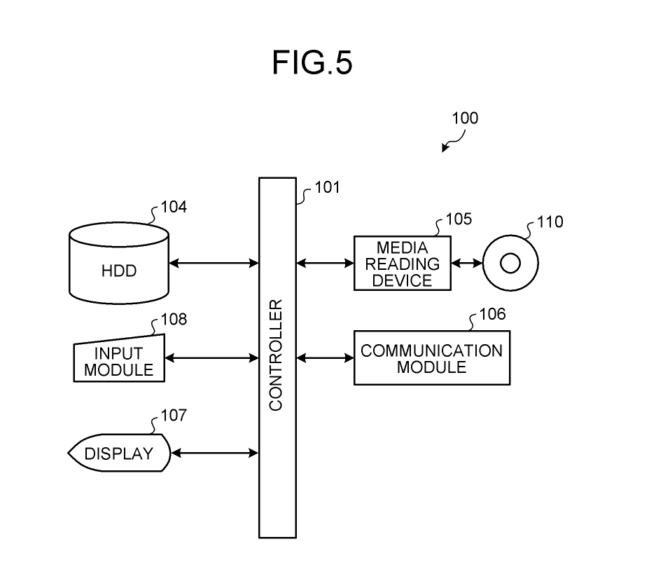

FIG. 5 is a block diagram illustrating one example of the server 100 in the embodiment. In the embodiment, the server 100 is configured as a web server, for example. The server 100 comprises a controller 101. The controller 101 comprises a CPU and a storage module, and controls respective components of the server 100. The storage module of the controller 101 comprises a ROM and a RAM, for example. The controller 101 is connected to a hard disk drive (HDD) 104, a media reading device 105, a communication module 106, a display 107, and an input module 108. The HDD 104 functions as a database of various types of data and is a storage module that stores therein an operating system (OS) and various application programs. The media reading device 105 stores therein information using a storage medium 110, distributes information externally, and acquires information externally, such as a digital versatile disc (DVD) drive. The communication module 106 transfers information by communicating with other external apparatuses through the network 500. The display 107 displays for operators progresses or results of processing, such as an LCD. The input module 108 is a pointing device with which an operator inputs commands and information to the controller 101, such as a keyboard or a mouse.

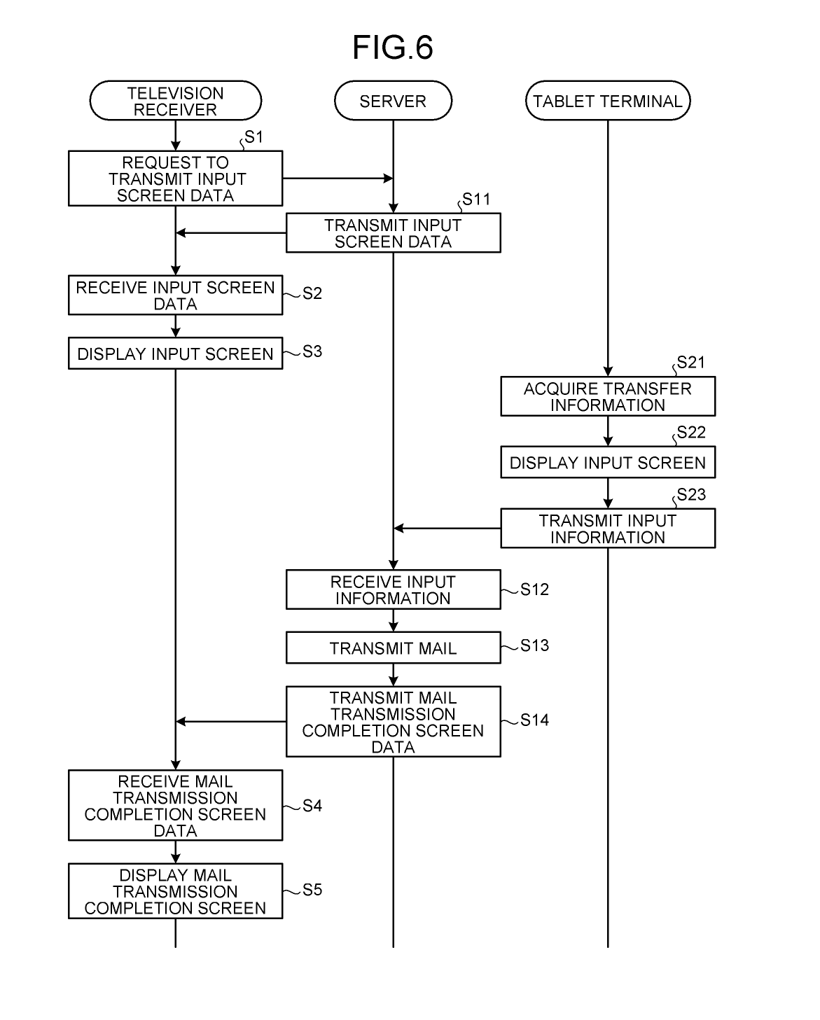

The following describes mail transmission processing that is one of the processing performed by the system 1 with reference to the flowchart illustrated in FIG. 6. In the embodiment, text of a mail transmitted by the television receiver 200 serving as the transmission origin can be input by either the television receiver 200 or the tablet terminal 300.

The controller 206 of the television receiver 200 displays a menu screen (not illustrated) on the display 216 when a signal indicating that the menu key is operated is input from the remote controller 250 operated by a user. When a mail send button in the menu screen is selected using the remote controller 250, the controller 206 requests the server 100 to transmit input screen data (S1).

Upon receipt of the request of the transmission of the input screen data from the television receiver 200, the controller 101 of the server 100 transmits the input screen data to the television receiver 200 (S11).

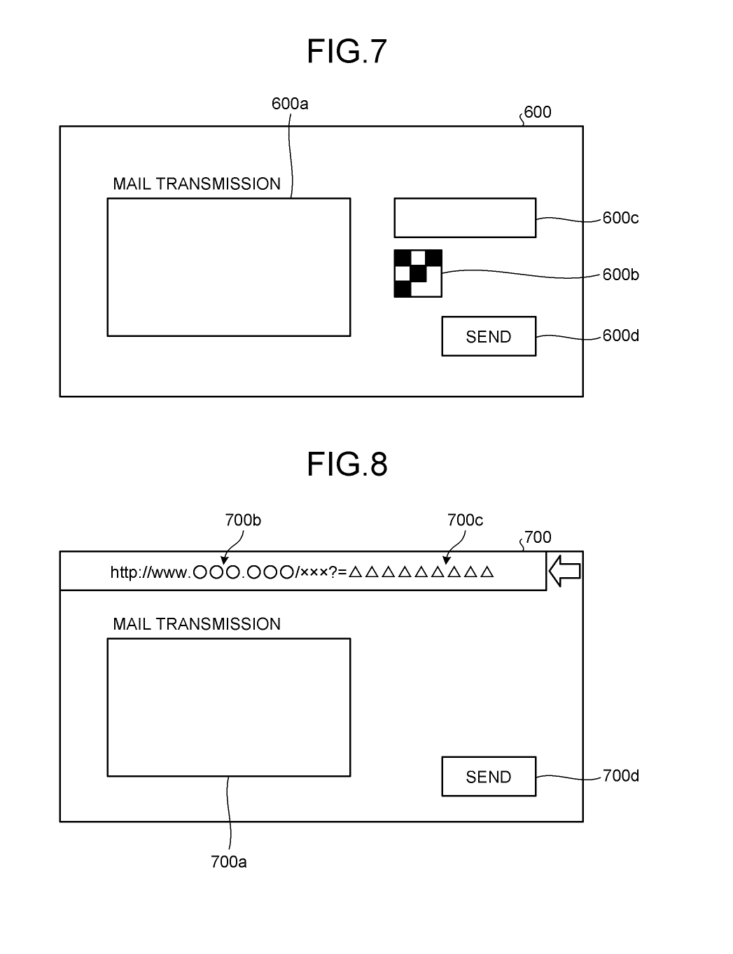

Upon receipt of the input screen data from the server 100, the controller 206 (the receiving module 251 and the information providing module 252) of the television receiver 200 displays an input screen 600 (a mail transmission screen, refer to FIG. 7) using the input screen data (S3).

FIG. 7 illustrates one example of the input screen 600. The input screen 600 comprises an input area 600a (a first input area or an input block) that receives text input, a two-dimensional code 600b (a code symbol or transfer information), a message display section 600c, and a send button 600d. The input area 600a receives the text input using the remote controller 250, for example. The transfer information is coded and symbolized as the two-dimensional code 600b. In the embodiment, a single two-dimensional code 600b is displayed for an input screen 600 having either one or more input area 600a. That is, a single two-dimensional code 600b is provided for each input screen 600 even if a plurality of input areas 600a are provided on the input screen 600. The transfer information comprises identification information of an input area 700a (a second input area, refer to FIG. 8) and authentication information for using the input area 700a, for example. The input area 700a corresponds to the input area 600a displayed on the display 216. Here, text is capable of being input to the input area 600a. The input area 700a is displayed on the display 306 of the tablet terminal 300. In the embodiment, the identification information of the input area 700a corresponding to the input area 600a is the identification information (address information) of an input screen 700 (a screen, screen data, or image data, refer to FIG. 8) corresponding to the input screen 600, for example. The identification information of the input screen 700 is a uniform resource locator (URL), for example, and the authentication information is a token included in the URL. The authentication information is the information necessary to acquire the input screen 700 and provides an access authority to the input screen 700 (the screen data). The authentication information (token) is randomly produced by the server 100, for example. The transfer information (the identification information and the authentication information) may be transmitted from the server 100 by being included in the screen data of the input screen 600 or transmitted from the server 100 as another data different from the screen data together with the screen data, for example, at S11. The message display section 600c displays a message such as “You can start typing”. The message display section 600c may not be displayed. In this way, the controller 206 displays the transfer information as the two-dimensional code 600b (image) in the input screen 600 having the input area 600a so as to provide a state where the image capturing module 307 of the tablet terminal 300 can acquire the transfer information.

The controller 206 transmits mail transmission information comprising information on text input to the input area 600a to the server 100 when it is determined that the send button 600d is selected by the remote controller 250, for example. In this case, the server 100 transmits a mail to a destination (address) included in the mail transmission information using the received mail transmission information. The following describes an example where the text input is performed by the tablet terminal 300 without the selection of the send button 600d.

When a user performs image capturing using the tablet terminal 300 in a state where the two-dimensional code 600b can be captured, the controller 302 controls the image capturing module 307 so as to capture the two-dimensional code 600b, and acquires the transfer information (S21). The controller 302 accesses the server 100 using the acquired transfer information and displays the input screen 700 (refer to FIG. 8) on the display 306 (S22). Specifically, the controller 302 transmits the transfer information to the server 100. The controller 101 of the server 100, which receives the transfer information, transmits the data of the input screen 700 to the tablet terminal 300 only when the predetermined authentication information (the authentication information transmitted at S11) is included in the transfer information. In the embodiment, the use of the input screen 700 (the input area 700a, refer to FIG. 8) is permitted to the tablet terminal 300 (the information processor) from which the authentication information transmitted to the server 100 is received by the server 100 as the first authentication information. For example, when receiving the authentication information from the tablet terminal 300, the controller 101 of the server 100 transmits the data of the input screen 700 to the tablet terminal 300 only, and even when receiving the same authentication information from another information processor after the reception, the controller 101 of the server 100 transmits no data of the input screen 700 to the other information processor. In the embodiment, the authentication information is used to permit the text input through the input area 700a for a number of times equal to or smaller than a threshold value (e.g., one in the embodiment). In the embodiment, a case is described where the controller 101 of the server 100 receives the authentication information transmitted from the tablet terminal 300 as the first authentication information.

FIG. 8 illustrates one example of the input screen 700. The input screen 700 comprises the input area 700a (the second input area, an input area, or an input block) that receives the text input, a URL 700b that is the URL of the input screen 700, and a send button 700d. The input area 700a corresponds to (is associated with) the input area 600a of the input screen 600. The text input to the input area 700a is performed, through the touch panel 305, by selecting keys on a software keyboard (screen keyboard) displayed on the display 306 by predetermined operation. The URL 700b comprises a token 700c.

The controller 302 transmits the mail transmission information comprising information on text input to the input area 700a to the server 100 when it is determined that the send button 700d is selected using the touch panel 305, for example (S23).

The controller 101 of the server 100 receives the mail transmission information from the tablet terminal 300 (S12). In this way, the server 100 receives from the tablet terminal 300 the information on the text input to the input area 700a displayed on the display 306 using the touch panel 305. Then, the controller 101 transmits a mail including a message included in the received mail transmission information to the destination (address) included in the mail transmission information (S13). In this case, the mail transmission origin is the television receiver 200. Then, the controller 101 transmits mail transmission completion screen data to the television receiver 200 (S14).

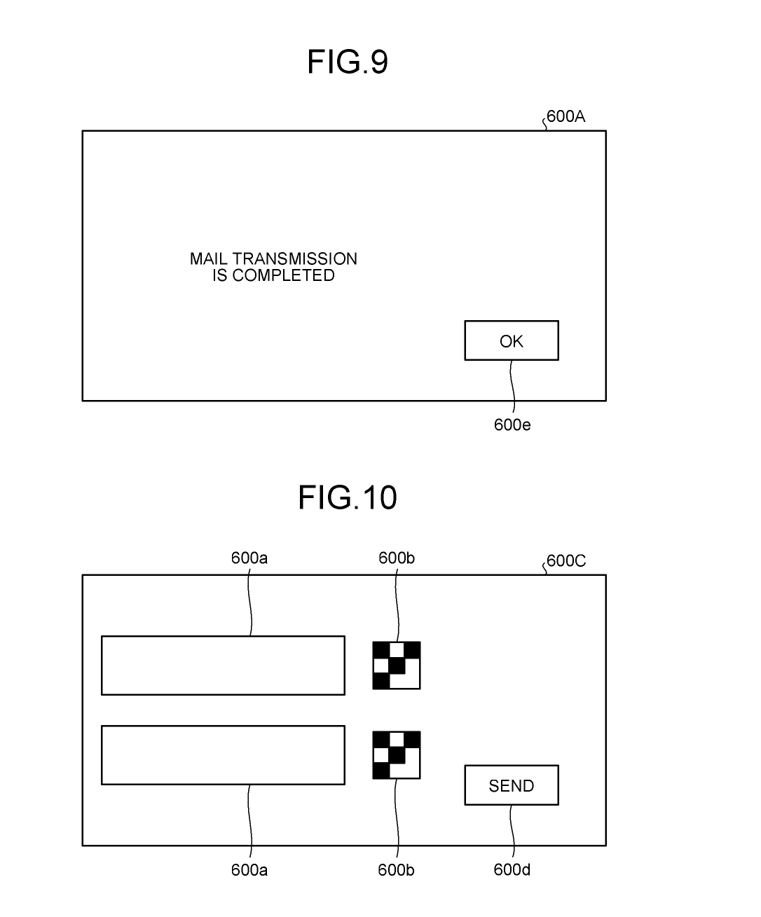

The controller 206 (the information receiving module 253) of the television receiver 200 receives the mail transmission completion screen data from the server 100 (S4). The mail transmission completion screen data is one example of information indicating that text is input through the input area 700a. The mail transmission completion screen data is also one example of information responding to the authentication information (first information). Then, the controller 206 (the screen changing module 254) displays a mail transmission completion screen 600A (refer to FIG. 9) on the display 216 using the received mail transmission completion screen data (S5). In this way, the controller 206 changes the screen of the display 216 when receiving the mail transmission completion screen data as the information indicating that the text input ends. As illustrated in FIG. 9, a message indicating that the mail transmission is completed (e.g., “mail transmission is completed”) is displayed on the mail transmission completion screen 600A. The mail transmission completion screen 600A displays an OK button 600e. When the OK button 600e is selected by the remote controller 250, the screen of the display 216 changes to another screen from the mail transmission completion screen 600A.

In the embodiment, when the send button of either the input screen 600 or the input screen 700 (the send button 600d on the input screen 600 or the send button 700d on the input screen 700) is selected as operation for fixing the text input, no text input is received after the operation and text input in the other screen (the input screen 600 or the input screen 700) are invalidated, for example. When the send button 600d on the input screen 600 is selected in this case, the input screen 700 disappears or the send button 600d grays out, for example.

In the embodiment as described above, the television receiver 200 provides a state where the tablet terminal 300 having the display 306 can acquire the transfer information that comprises the identification information of the input area 700a corresponding to the input area 600a displayed on the display 216 and the authentication information for using the input area 700a. Here, the text is capable of being input to the input area 600a. In the embodiment, the transfer information is indicated by the two-dimensional code 600b, for example. The television receiver 200 receives the mail transmission completion screen data indicating that the text input is performed from the server 100 that receives the information of the text input to the input area 700a displayed on the display 306 using the touch panel 305 from the tablet terminal 300. As a result, according to the embodiment, it is possible to perform the text input with respect to the input area 700a displayed on the display of the tablet terminal 300 instead of performing the text input with respect to the input area 600a displayed on the display 216 of the television receiver 200, by capturing the two-dimensional code 600b using the image capturing module 307 of the tablet terminal 300. It requires no preliminary setting for cooperation between the television receiver 200 and the tablet terminal 300. According to the embodiment, it is possible to readily substitute the text input with respect to the input area 700a of the tablet terminal 300 for the text input with respect to the input area 600a of the television receiver 200. The embodiment does not require a user to perform setting for cooperation between apparatuses (the television receiver 200 and the tablet terminal 300), thereby making it relatively easy to perform the text input operation.

In the embodiment, the transfer information comprises the authentication information (token). Asa result, the server 100 transmits the data of the input screen 700 (permits the accesses to the input screen 700) when predetermined authentication information is included in the transfer information whereas the server 100 can refuse the transmission of the data of the input screen 700 when no predetermined authentication information is included in the transfer information. The server 100 can associate (make an association with) the television receiver 200 with (and) the tablet terminal 300 on the basis of the authentication information.

In the embodiment, the television receiver 200 changes the screen of the display 216 when receiving the information indicating that the text input is performed (is completed) (e.g., the mail transmission completion screen data) from the server 100. As a result, the embodiment makes it possible for a user to grasp the completion of the processing (e.g., the mail transmission processing).

### Modification

FIG. 10 is a schematic diagram illustrating one example of an input screen 600C displayed on the display 216 of the television receiver 200 according to a modification of the first embodiment. In the modification, the input screen 600C comprises multiple input areas 600a (first input areas). In the modification, an input screen having an input area corresponding to the input area 600a is displayed on the tablet terminal 300 when one of the input areas 600a is captured by the image capturing module 307.

### Second Embodiment

A second embodiment differs from the first embodiment in that the transfer information is stored in the storage module 217a of the wireless communication module 217 in the television receiver 200. In the second embodiment, the wireless communication module 308 of the tablet terminal 300 is an example of the acquisition module.

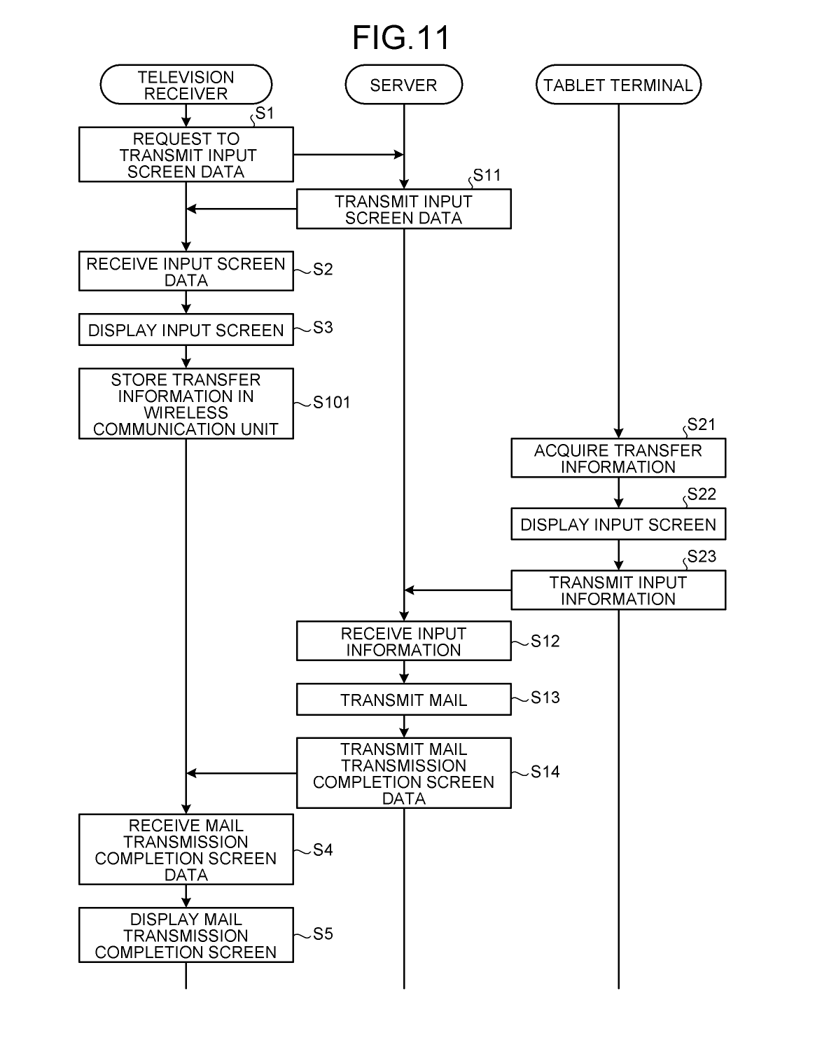

The procedure of the mail transmission processing in the embodiment is described with reference to the flowchart of FIG. 11 focusing mainly on a part different from the processing in the flowchart of FIG. 6. In the embodiment, at S11, the controller 101 of the server 100 transmits the transfer information to the television receiver 200 together with the input screen data.

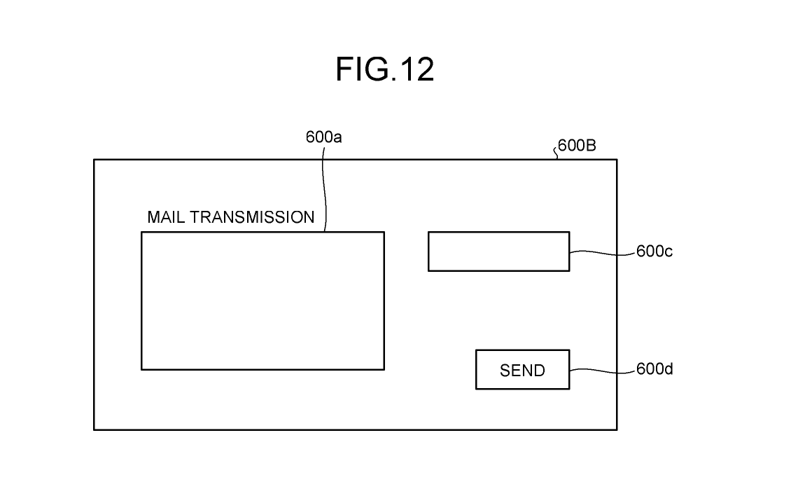

The controller 206 of the television receiver 200 receives the input screen data and the transfer information at S2, and displays an input screen 600B (refer to FIG. 12) on the display 216 at S3. As exemplarily illustrated in FIG. 12, the input screen 600B of the embodiment comprises the input area 600a, the message display section 600c, and the send button 600d in the same manner as the input screen 600. The input screen 600B of the embodiment is not provided with the two-dimensional code 600b. In the embodiment, the message display section 600c displays a message such as “You can input text by touching the reading mark with a device”.

Then, the controller 206 of the television receiver 200 stores the transfer information received from the server 100 in the storage module 217a of the wireless communication module 217 (S101). As a result, the transfer information stored in the storage module 217a is transmitted to the wireless communication module 308 from the wireless communication module 217 when the wireless communication module 308 of the tablet terminal 300 is caused to make contact with (approach to) the reading mark 221 of the television receiver 200. The wireless communication module 308 receives (acquires) the transmitted transfer information and outputs it to the controller 302 of the tablet terminal 300. When the transmission and the receiving of the transfer information are completed, the television receiver 200 may output a sound indicating the completion. The processing subsequent to S101 is performed in the same manner as the first embodiment.

In the embodiment, the transfer information can comprise the information on text input to the input area 600a. For example, when a user partway performs the text input with respect to the input area 600a using the remote controller 250 and thereafter performs the remaining text input using the tablet terminal 300, the controller 206 stores the transfer information comprising the information of the text input to the input area 600a in the storage module 217a. The controller 206 updates the transfer information after every addition or deletion of text to the input area 600a. The controller 302 of the tablet terminal 300 displays (inputs) the text input to the input area 600a in the input area 700a using the transfer information acquired from the television receiver 200. In this way, in the embodiment, the information on the text input to the input area 600a can be taken over by the tablet terminal 300.

In the embodiment as described above, the controller 206 stores the transfer information in the storage module 217a from which the wireless communication module 308 can acquire information in a wireless communication manner so as to provide a state where the wireless communication module 308 of the tablet terminal 300 can acquire the transfer information. As a result, according to the embodiment, it is possible to perform the text input with respect to the input area 700a displayed on the display 306 of the tablet terminal 300 instead of performing the text input with respect to the input area 600a displayed on the display 216 of the television receiver 200 by the wireless communication module 308 of the tablet terminal 300 closely provided to the wireless communication module 217 of the television receiver 200 acquiring the transfer information from the wireless communication module 217 in a wireless communication manner. It requires no preliminary setting for cooperation between the television receiver 200 and the tablet terminal 300. The embodiment does not require a user to perform setting for cooperation between the apparatuses (the television receiver 200 and the tablet terminal 300), thereby making it relatively easy to perform the text input operation.

### Modification

The following describes a modification of the second embodiment. In the modification, an input screen (not illustrated) displayed on the display 216 of the television receiver 200 comprises multiple input areas 600a, for example. When a cursor is positioned on any one of the input areas 600a of the input screen and a state is provided where text can be input to the input area 600a, the controller 206 stores only the transfer information of the input area 600a on which the cursor is positioned in the storage module 217a of the wireless communication module 217. When the transfer information of the other input area 600a is stored in the storage module 217a, the transfer information is eliminated. As a result, one of the input areas 600a can be identified as an input target with the position of the cursor.

As described above, according to the embodiments and modifications, it is possible to obtain a text input method in which the text input operation is relatively readily performed without requiring a user to perform the setting for cooperation between apparatuses (the television receiver 200 and the tablet terminal 300), the television receiver 200, and a computer program.

While certain embodiments and modifications have been described, these embodiments and modifications have been presented by way of example only, and are not intended to limit the scope of the inventions. Indeed, the novel embodiments and modifications described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the controller 206 of the television receiver 200 may produce the authentication information and transmit it to the server 100, and the authentication information may be shared by the television receiver 200 and the server 100.

The transfer information transmitted to the television receiver 200 by the server 100 may have an expiry date.

The transfer information may be displayed with text instead of the two-dimensional code 600b, the image capturing module 307 of the tablet terminal 300 may capture the text, and the controller 302 of the tablet terminal 300 may perform text recognition processing on the imaged data to recognize the transfer information.

The electronic device is not limited to the television receiver 200. Examples of the electronic device may include a computer, a video image display, a projector, and a commuter pass ticketing machine. The electronic device may be installed in facilities such as stations, shops, hotels, and government offices, and in cities such that the general public can use it. The input screen is not limited to the input screen for mail. Any input screen in which information can be input is applicable. For example, a computer installed in a hotel may display a screen as an input screen in which a message such as a feedback after staying at the hotel can be displayed. For another example, a projector may display an input area together with a digital signage.

The information processor is not limited to the tablet terminal 300. Examples of the information processor may include a smartphone, a mobile phone, and a personal digital assistant (PDA).

The threshold of the number of permissions for input of text through the input area 700a is not limited to one. The threshold may be two or more.

Moreover, the various modules of the systems described herein can be implemented as software applications, hardware and/or software modules, or components on one or more computers, such as servers. While the various modules are illustrated separately, they may share some or all of the same underlying logic or code.

What is claimed is:

1. A text input method comprising:
displaying, by a first apparatus comprising a first display, a first input area configured to receive text input on the first display;
providing, by the first apparatus, identification information of a second input area configured to be displayed on a second display of a second apparatus, the second input area corresponding to the first input area;
providing, by the first apparatus, authentication information for using the second input area; and
receiving, from a server, information indicative of text being input through the second input area.

2. The text input method of claim 1, wherein the authentication information is configured to permit the text to be input through the second input area for a number of times equal to or smaller than a threshold value.

3. The text input method of claim 1, wherein a screen of the first display is changed when the information indicative of the text being input is received.

4. The text input method of claim 1, wherein the identification information is a uniform resource locater (URL) of a screen comprising the second input area.

5. The text input method of claim 1, wherein transfer information comprising the identification information and the authentication information is displayed as an image on a screen comprising the first input area in a state in which the second apparatus is capable of acquiring the transfer information.

6. The text input method of claim 5, wherein the image is a code symbol.

7. The text input method of claim 5, wherein a single image is displayed as the image on a screen comprising at least one first input area.

8. The text input method of claim 1, wherein transfer information comprising the identification information and the authentication information is configured to be stored in a storage module from which the second apparatus is capable of acquiring information in a wireless communication manner, in a state in which the second apparatus is capable of acquiring the transfer information.

9. The text input method of claim 8, wherein the transfer information comprises information of a text input to the first input area.

10. An electronic device comprising:
a display module configured to display, on a first display of the electronic device, a first input area configured to receive text input on the first display;
an information providing module configured to provide identification information of a second input area configured to be displayed on a second display of other device, and to provide authentication information for using the second input area, the second input area corresponding to the first input area; and
an information receiver configured to receive from a server information indicative of text being input through the second input area.

11. A computer-readable, non-transitory storage medium having stored thereon a computer program which is executable by a computer, the computer program controlling the computer to execute functions of:
displaying, by a first apparatus comprising a first display, a first input area configured to receive text input on the first display,
providing, by the first apparatus, identification information of a second input area configured to be displayed on a second display of a second apparatus, the second input area corresponding to the first input area;
providing, by the first apparatus, authentication information for using the second input area; and
receiving, from a server, information indicative of text being input through the second input area.
